(19) United States
(12) Patent Application Publication
(10) Pub. No.: US 2006/0217155 A1
(43) Pub. Date: Sep. 28, 2006

(54) Method of determining a relocation start in a mobile communication system, radio network controller having a relocation start determination function, and mobile communication system including the radio network controller

(75) Inventor: Hiroaki Kuwano, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/377,373

(22) Filed: Mar. 17, 2006

(30) Foreign Application Priority Data
Mar. 24, 2005 (JP) 2005-086319

(51) Int. Cl. H04B 1/38

(52) U.S. Cl. 455/560; 455/436

(57) ABSTRACT

A method of determining a relocation start in a mobile communication system in which each of service areas is constituted of a plurality of cells, includes: determining, when a mobile station moves into a different service area, whether the service area is a relocation inhibition target or not based on prestored first data; determining, when the service area is not a relocation inhibition target, whether a cell where the mobile station exists is a relocation inhibition target or not based on prestored second data; and determining advisability of a start of relocation processing based on the determination results.

### BACKGROUND OF THE INVENTION

1. Field of the Invention

The present invention relates to determination of start of relocation processing made when a mobile station moves out of control of a given radio network controller to be under control of another radio network controller in a mobile communication system. In particular, the invention relates to its determination method, a radio network controller equipped with a relocation start determination function, and a mobile communication system including the radio network controller.

2. Description of the Related Art

In the mobile communication system, when the mobile station moves to another cell during communication, a communication path between the mobile station and a mobile communication core network is maintained to continue the communication by handover processing. For example, even when the mobile station moves to a cell controlled by another radio network controller, the communication is continued by a communication line between the radio network controllers. However, if a detour or the like occurs in the communication path changed by the handover, processing of setting a more efficient communication path again, i.e., relocation, must be carried out.

An outline of the relocation and conventional problems will be described with reference to the drawings. FIG. 1 is a schematic diagram showing an example of a configuration of the Universal Mobile Telecommunications System (UMTS).

The UMTS shown in FIG. 1 includes a core network (CN) 10, radio network controllers (RNC) 20 and 21, Node Bs 30 to 33, and a mobile station 40. The RNCs 20 and 21 (which correspond to a base station controller in a general mobile communication network system) are connected to the core network 10 (e.g., MSC (Mobile Switching Center) or SGSN (Serving GPRS Support Node) is included) through communication lines (i.e., interfaces) 11 and 12, respectively. The RNC 20 is connected to the Node Bs 30 and 31 (which correspond to a radio base station in a general mobile communication network system) through communication lines 201 and 202 to control them, respectively. A radio service area (covered area) which each Node B is in charge of is divided into a plurality of cells. In FIG. 1, the Node B 30 controls cells #301 and #302. The Node B 31 controls cells #311 and #312. On the other hand, the RNC 21 is connected to the Node Bs 32 and 33 through communication lines 211 and 212 to control them, respectively. The Node B 32 controls cells #321 and #322. The Node B 33 controls cells #331 and #332. In FIG. 1, the numbers of nodes (i.e., the core network, the radio network controller, the Node B and the mobile station) and cells are simplified for easier explanation, and they are not limited to the shown numbers.

In FIG. 1, when the mobile station 40 in the cell #301 makes a call, the RNC 20 obtains information from the mobile station 40 through the Node B 30 to control the mobile station 40. As a result, a communication path is established along a route of the mobile station 40—the Node B 30—the communication line 201—the RNC 20—the communication line 11—the core network 10. Thereby connection with the mobile communication network is established to start communication with a communication counterpart. When the mobile station 40 moves into another cell in this state, the RNC 20 executes handover processing. For example, it is presumed that the mobile station 40 moves into the cell #311 of which the Node B 31 is in charge. The Node B 31 is under control of the RNC 20, so the RNC 20 controls the Node B 31 to switch the communication line 201 to the communication line 202, thereby continuing the communication with the mobile station 40.

When the mobile station 40 moves into the cell #321, the Node B 32 that is in charge of the cell #321 is not under control of the RNC 20. In this case, the RNC 21 recognizes the movement of the mobile station 40 into the cell #321 based on information from the Node B 32. Then the RNC 21 transmits the information to the RNC 20 through a communication line 200 between the RNCs 20 and 21. Accordingly, the call made by the mobile station 40 is continued by the route extending along the RNC 20, the communication line 200, the RNC 21, the communication line 211, and the Node B 32. At this time, the mobile station 40 is still under control of the RNC 20. This state is shown in FIG. 2. However, if the mobile station 40 continues the communication with the counterpart for a long time in this state, the communication line 200 between the RNCs 20 and 21 is secured for a long time. Hence, a communication line with a large band capacity must be prepared between the radio network controllers in which mobile stations come and go frequently. However, since there is a limit on a band capacity of the communication line, long-time use of the communication line 200 is not preferable from the standpoint of efficient communication line use.

Thus, as shown in FIG. 3, “relocation” is processing of transferring control of the mobile station 40 from the RNC 20 to the RNC 21, and switching the communication path between the mobile station 40 and the core network 10 from a detour state connection through the communication lines 11 and 200 to a direct connection of the communication line 12. As the relocation processing enables switching of a redundant communication path to a more efficient communication path, it is possible to increase efficiency of communication line use.

However, the conventional method of starting relocation processing has had the following problems. As the relocation is complex processing where the mobile station, the Node B, the radio network controller, and the core network are all involved, frequent execution is not desirable. If relocation processing is executed as soon as the mobile station is handed over to a cell under control of a radio network controller different from the previous radio network controller, when there is a mobile station which comes and goes near a boundary of two areas covered by two radio network controllers respectively, relocation processing frequently occurs. In FIG. 3, a covered area of the RNC 20 contains all the cells #301, #302, #311, and #312. A covered area of the RNC 21 contains all the cells #321, #322, #331, and #332.

Thus, to switch the redundant communication path to a more efficient communication path at a proper time while preventing a frequent occurrence of relocation processing, relocation processing may be started when the mobile station moves apart from the boundary of the area covered by the radio network controller by a certain distance.

This state is shown in FIG. 4. That is, when the mobile station moves apart from a boundary of an area 300 covered by all the cells under control of the RNC 20 by a certain distance L in FIG. 4, relocation processing is started. In FIG. 4, areas covered by the adjacent RNCs 21 to 26 are arranged around the covered area 300 of the RNC 20.

However, in each radio network controller, it is technically very difficult to detect and understand coordinate information of locations of all mobile stations under own control in real time. Such a technology is described as a background of U.S. Pat. No. 6,483,818. Hence, it is also very difficult for the radio network controller to detect a distance between the boundary of the covered area of the radio network controller and the location of the mobile station in real time.

Japanese Patent Laid-Open Publication JP 2002-359871 A discloses a technology of preventing a frequent occurrence of relocation processing by using a timer.

When there is a communication line with a very large band capacity prepared between the radio network controllers, there may be a wish to prevent an occurrence of complex relocation processing rather than to make a communication path efficient. However, if relocation processing is started under uniform conditions that the mobile station moves apart from the boundary of the covered area by a certain distance or a certain period of time passes, a case may occur where unfavorable (unnecessary) relocation processing is started.

### SUMMARY OF THE INVENTION

The present invention has been made in view of the foregoing problems.

An exemplary feature of the present invention is to provide a method of determining a relocation start and a radio network controller having a relocation start determination function in a mobile communication system which needs no complex processing and enables appropriate determination of start of relocation processing.

The present invention provides a method of determining a relocation start in a mobile communication system in which each of service areas is constituted of a plurality of cells, including: determining, when a mobile station moves into a different service area, whether the service area is a relocation inhibition target or not based on prestored first data; determining, when the service area is not a relocation inhibition target, whether a cell where the mobile station exists is a relocation inhibition target or not based on prestored second data; and determining advisability of a start of relocation processing based on the determination results.

Further, the present invention provides a radio network controller for controlling a mobile station in a mobile communication system in which each of service areas covered by each of radio network controllers is constituted of a plurality of cells, including: first storage for storing information to determine an adjacent radio network controller of a relocation inhibition target; second storage for storing information to determine a cell of a relocation inhibition target in a service area covered by an adjacent radio network controller; and a relocation start determination unit for determining advisability of a start of relocation processing by referring to the first and second storage when a mobile station moves into a service area covered by an adjacent radio network controller.

Further, the present invention provides a mobile communication system in which each of service areas is constituted of a plurality of cells, the system executing: determining, when a mobile station moves in to a different service area, whether the service area is a relocation inhibition target or not based on prestored first data; determining, when the service area is not a relocation inhibition target, whether a cell where the mobile station exists is a relocation inhibition target or not based on prestored second data; and determining advisability of a start of relocation processing based on the determination results.

According to the present invention, since necessity for the start of relocation processing is determined by referring to the database based on the information about the cell of the moving destination of the mobile station and the adjacent radio network controller for controlling the cell, complex processing such as real-time detection of the location coordinates of the mobile station is made unnecessary. Moreover, a proper and efficient relocation processing is enabled by preventing unnecessary start of relocation processing.

### BRIEF DESCRIPTION OF THE DRAWINGS

The above and other exemplary aspects, features and advantages of the present invention will become more apparent from the following detailed description when taken in conjunction with the accompanying drawings wherein:

FIG. 1 is a schematic diagram showing an example of a UMTS configuration;

FIG. 2 is a conceptual diagram showing a handover situation of a mobile station in the UMTS;

FIG. 3 is a conceptual diagram showing a situation of executing relocation processing in the UMTS;

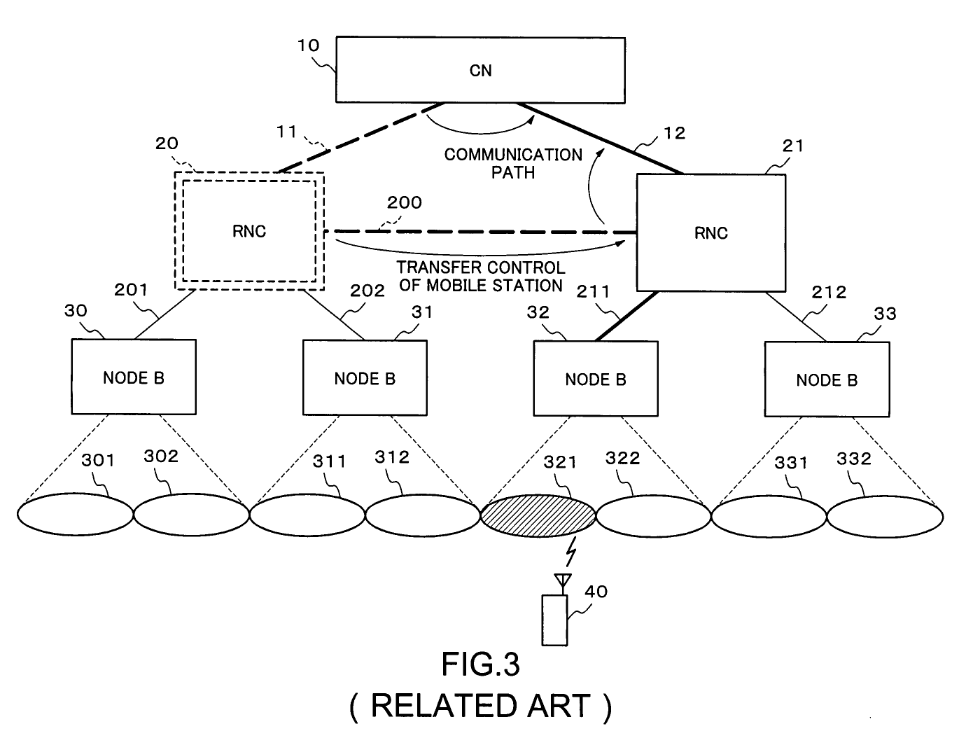

FIG. 4 is a plan view showing an example of an area where relocation processing is started;

FIG. 5 is a schematic diagram showing an example of a UMTS configuration to which a first exemplary embodiment of the present invention is applied;

FIG. 6 is a functional block diagram showing a configuration of a relocation start determination unit 503 according to the first exemplary embodiment of the present invention;

FIG. 7 is a diagram showing a configuration example of a first database 501 according to the first exemplary embodiment of the present invention;

FIG. 8 is a diagram showing a configuration example of a second database 502 according to the first exemplary embodiment of the present invention;

FIG. 9 is a diagram showing an example of cell arrangement according to the first exemplary embodiment of the present invention;

FIG. 10 is a flowchart showing a database registration operation according to the first exemplary embodiment of the present invention;

FIG. 11 is a conceptual diagram showing a handover situation of a mobile station 40 according to the first exemplary embodiment of the present invention;

FIG. 12 is a flowchart showing an operation of determining advisability of a relocation start according to the first exemplary embodiment of the present invention;

FIG. 13 is a conceptual diagram showing a situation of executing relocation processing according to the first exemplary embodiment of the present invention;

FIG. 14 is a flowchart showing a database registration operation according to a second exemplary embodiment of the present invention;

FIG. 15 is a flowchart showing an operation of determining advisability of a relocation start according to the second exemplary embodiment of the present invention;

FIG. 16 is a flowchart showing a database registration operation according to a third exemplary embodiment of the present invention;

FIG. 17 is a diagram showing a configuration example of a first database 501 according to the third exemplary embodiment of the present invention;

FIG. 18 is a flowchart showing an operation of determining advisability of a relocation start according to the third exemplary embodiment of the present invention;

FIG. 19 is a flowchart showing a database registration operation according to a fourth exemplary embodiment of the present invention; and

FIG. 20 is a flowchart showing an operation of determining advisability of a relocation start according to the fourth exemplary embodiment of the present invention.

### DETAILED DESCRIPTION OF THE EXEMPLARY EMBODIMENTS

Exemplary embodiments of the present invention will now be described in detail in accordance with the accompanying drawings.

### First Exemplary Embodiment

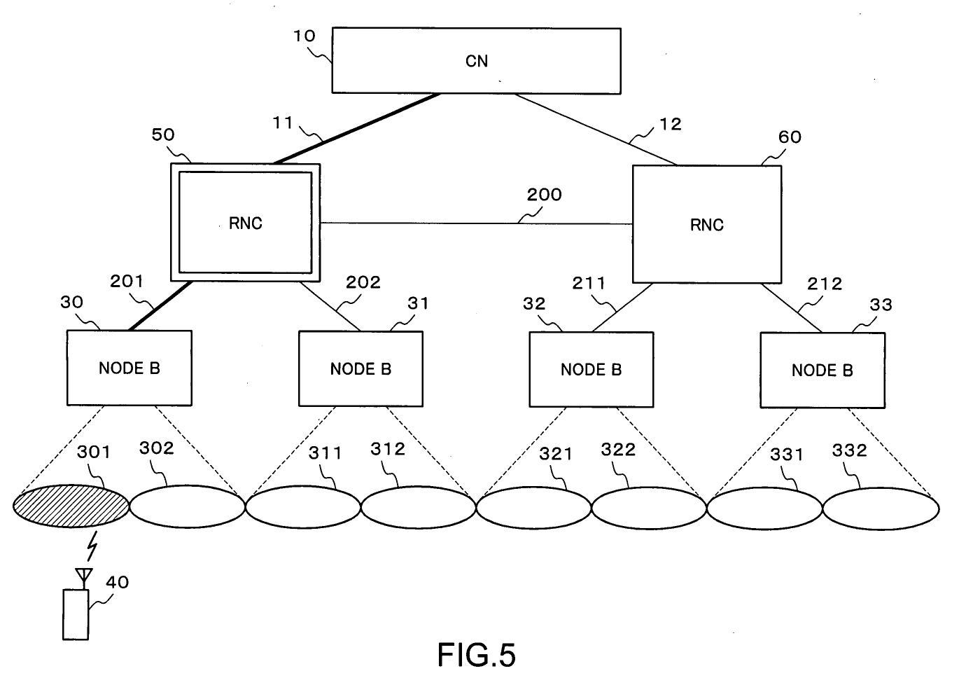

FIG. 5 schematically shows an example of a configuration of a universal mobile telecommunications system (UMTS) to which a first exemplary embodiment of the present invention is applied.

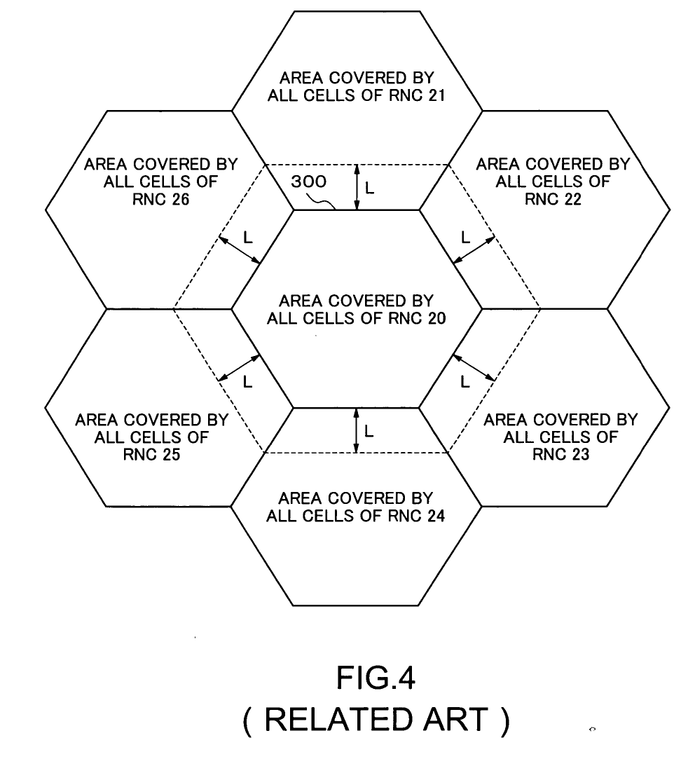

The UMTS shown in FIG. 5 includes a core network (CN) 10, radio network controllers (RNC) 50 and 60, Node Bs 30 to 33, and a mobile station 40. The RNCs 50 and 60 (which correspond to a base station controller in a general mobile communication network system) are connected to the core network 10 (e.g., MSC (Mobile Switching Center) or SGSN (Serving GPRS Support Node) is included) through communication lines (i.e., interfaces) 11 and 12, respectively. The RNC 50 is connected to the Node Bs 30 and 31 (which correspond to a radio base station in a general mobile communication network system) through communication lines 201 and 202 to control them, respectively. A radio service area controlled by each Node B is constituted of a plurality of cells. In FIG. 4, the Node B 30 controls cells #301 and #302. The Node B 31 controls cells #311 and #312. On the other hand, the RNC 60 is connected to the Node Bs 32 and 33 through communication lines 211 and 212 to control them, respectively. The Node B 32 controls cells #321 and #322. The Node B 33 controls cells #331 and #332. In FIG. 5, the numbers of cells and nodes (i.e., the core network, the radio network controller, the Node B and the mobile station) are smaller than the actual numbers for easier explanation, and they are not limited to the shown numbers.

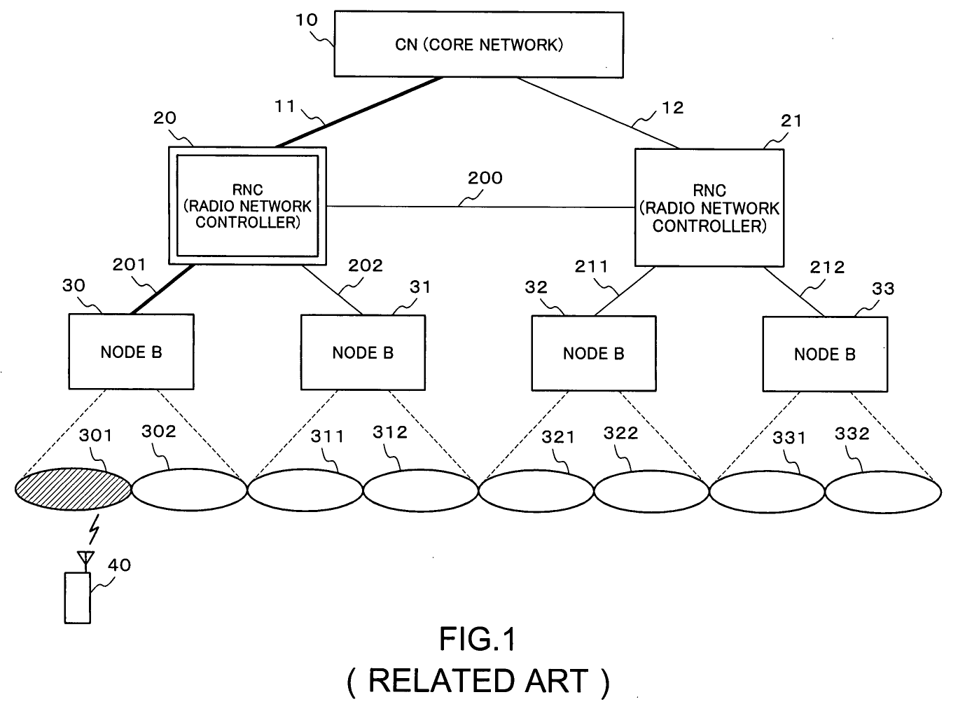

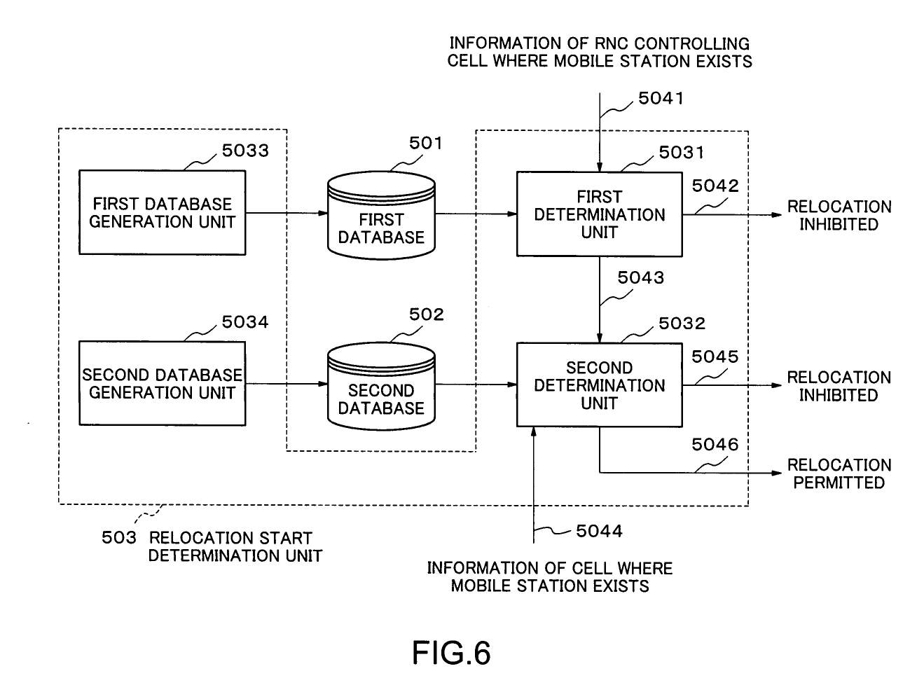

A large difference of the embodiment of the present invention from that of FIG. 1 is a configuration and an operation regarding start determination of relocation processing in the RNCs 50 and 60. In other words, each of the RNCs 50 and 60 has a configuration and a function which the conventional radio network controller has, and a relocation processing start determination function of the present invention. Actual relocation processing after once relocation start is determined is similar to that of the conventional case. Since the RNCs 50 and 60 are identical in configuration, referring to FIG. 6, a relocation start determination function of the present invention will be described by taking an example of the RNC 50.

Referring to FIG. 6, as compared with the conventional configuration, the RNC 50 additionally includes a first database 501, a second database 502, and a relocation start determination unit 503. As in the case of the conventional node or apparatus, the RNC 50 includes components and functions for executing fundamental functions of the radio network controller. For example, the fundamental functions include various functions such as an interface function with other nodes (core network 10, subordinate Node Bs 30 and 31, and peripheral RNC 60, and the like), a function of establishing/controlling a communication path (including handover and relocation execution), and a function of controlling the Node Bs 30 and 31 to control the mobile station 40.

To realize such fundamental functions, the radio network controller generally includes a main memory unit for storing various data and programs, and a central controller (central control unit) for executing the programs to achieve the fundamental functions based on the stored data. The central controller can be realized by a computer or a processor. The central controller executes a relocation processing program to realize a relocation processing function. According to the present invention, relocation processing after its start has been decided is similar to that of the conventional case.

The first database 501 and the second database 502 can be prepared in the main memory unit, or as storage devices separately from the main memory unit. The relocation start determination unit 503 can be realized by storing a program to execute its operation in the main memory unit. The central controller reads and executes the program to realize the relocation start determination unit 503 as a relocation start determination function of the RNC 50.

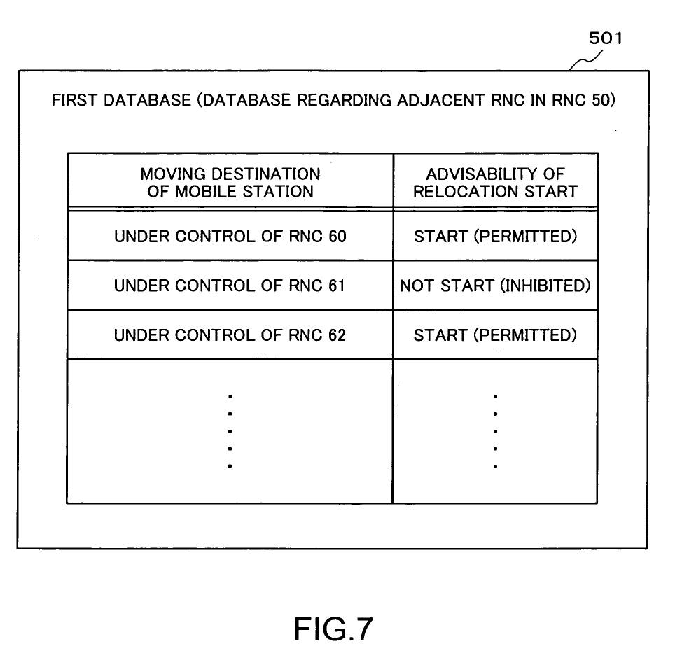

The first database 501 contains information registered to indicate whether or not to start relocation processing when the mobile station moves into its subordinate covered area (all the cells) regarding each of adjacent RNCs. In other words, the first database has information about necessity for starting relocation processing regarding each of adjacent RNCs. FIG. 7 shows an example of such information. When the mobile station 40 moves into a covered area under control of another RNC (i.e., RNC of a moving destination of the mobile station) adjacent to the previous RNC, the previous RNC that controls the mobile station first searches the first database 501. Information about the RNC where the mobile station now exists is retrieved from the first database 501 of FIG. 7 and, when the mobile station moves into the cell under control of the registered RNC, first determination is made as to permission of starting relocation processing.

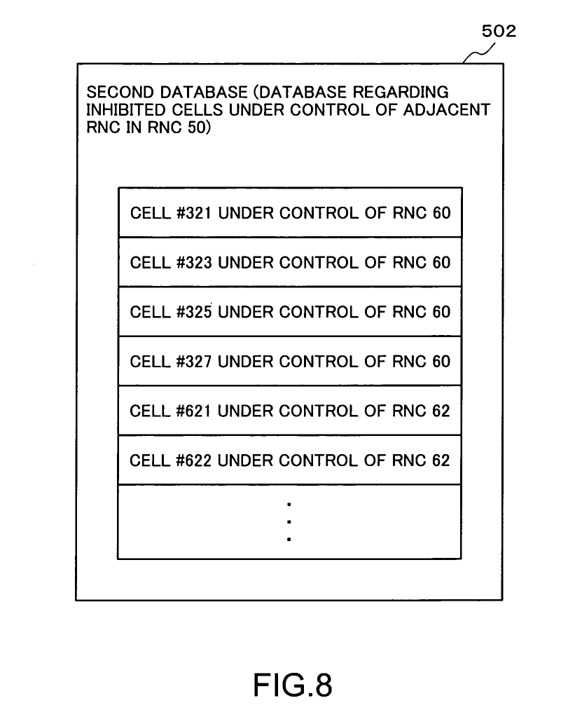

The second database 502 contains information regarding cells to be inhibited for a relocation processing start among cells under control of the adjacent RNCs. As described above, a relocation processing start should preferably be inhibited in a cell near a boundary of the covered area of the RNC. Accordingly, the second database 502 contains information regarding cells positioned near a boundary of a covered area of the RNC among the cells under control of the adjacent RNC (namely, registered cells are positioned outside and around the boundary of the covered area of the RNC 50 having the second database 502). FIG. 8 shows an example of such information. Thus, after the retrieval from the first database 501 (the first determination), checking is carried out as to whether a cell where the mobile station 40 now exists is a relocation start inhibition target or not (second determination).

The relocation start determination unit 503 includes a first determination unit 5031, a second determination unit 5032, a first database generation unit 5033, and a second database generation unit 5034.

The first determination unit 5031 makes first determination as to advisability of a relocation start based on RNC information 5041 of a moving destination of the mobile station 40 and the registered information of the first database 501. In other words, if the RNC of a moving destination of the mobile station 40 is a relocation start inhibition target, a determination result of the first determination unit 5031 is “RELOCATION INHIBITED” 5042 (i.e., start of relocation processing is inhibited) to finish the determination processing. If the RNC of a moving destination of the mobile station 40 is a relocation start permission target, relocation start permission 5043 is notified to the second determination unit 5032.

Upon reception of the relocation start permission 5043, the second determination unit 5032 makes second determination as to advisability of a relocation start based on information 5044 of the cell of a moving destination of the mobile station 40 (i.e., the cell where the mobile station 40 now exists) and the registered information of the second database 501. In other words, if the cell of a moving destination of the mobile station 40 is a relocation start inhibition target, a determination result of the second determination unit 5032 is “RELOCATION INHIBITED” 5045. If the cell of a moving destination of the mobile station 40 is not a relocation start inhibition target, a determination result of the relocation start permission is made as “RELOCATION PERMITTED” 5046.

The first database generation unit 5033 generates information to be registered in the first database 501. The second database generation unit 5034 generates information (relocation start inhibition target cells) to be registered in the second data base. By inputting each of necessary information from a maintenance terminal (not shown) generally provided in the RNC 50, the first database generation unit 5033 and the second database generation unit 5034 create and register the first database 501 and the second database 502, respectively.

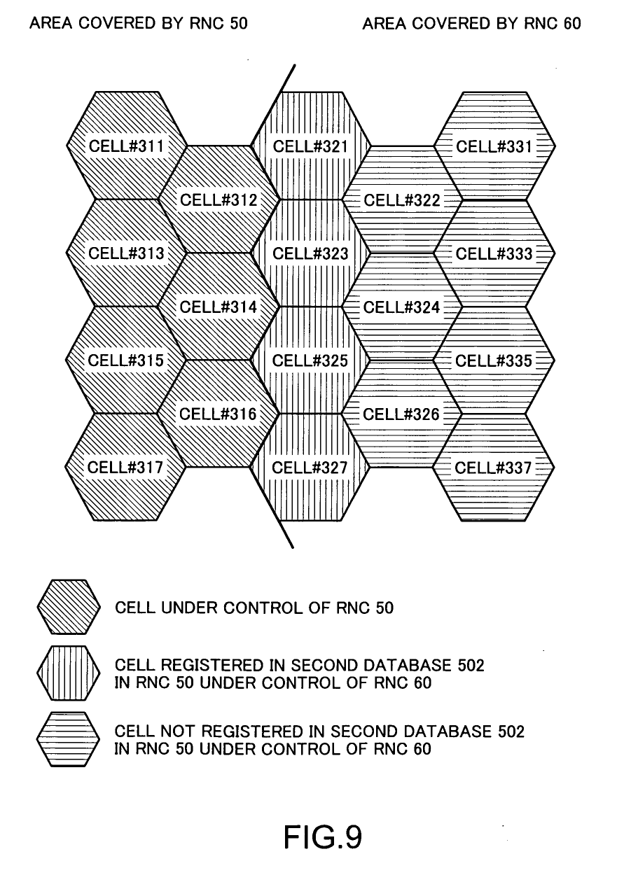

Next, a registration operation in the database according to the first exemplary embodiment of the present invention will be described. FIG. 9 shows an example of cell arrangement according to the first exemplary embodiment of the invention. As a specific example, when seen from the RNC 50, a relocation start is basically permitted for cells under control of the adjacent RNC 60. However, a relocation start is inhibited for cells #321, #323, #325, and #327 near the boundary between the covered areas of the RNCs 50 and 60. A relocation start is not inhibited for the other cells (not near the boundary), e.g., #322, #324, #326, #331, #333, #335, and #337. Though not shown in FIG. 5 and FIG. 9, there are actually other adjacent RNCs in addition to the RNC 60. Accordingly, information regarding these other adjacent RNCs and their cells must be registered in the first database 501 and the second database 502.

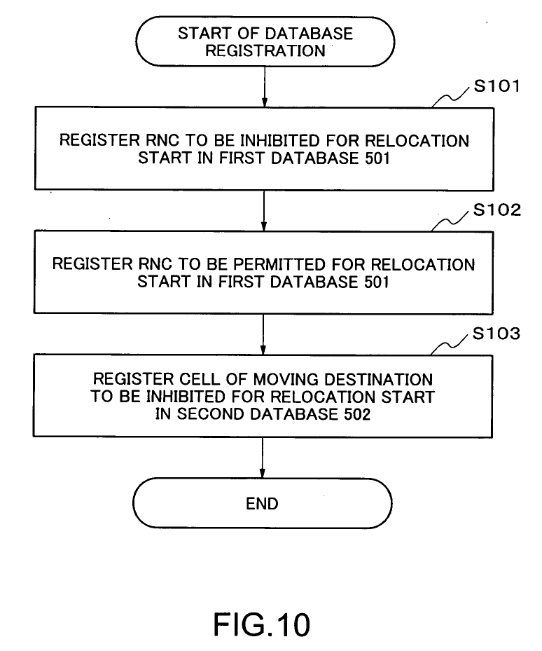

FIG. 10 is a flowchart showing a database registration operation according to the first exemplary embodiment of the present invention. First, the first database generation unit 5033 creates a database regarding an adjacent radio network controller of a moving destination of the mobile station 40 to be inhibited for a relocation start, and registers the database in the first database 501 (Step S101 of FIG. 10). Next, the second database generation unit 5034 registers an adjacent radio network controller of a moving destination of the mobile station 40 to be permitted for a relocation start in the second database 502 (Step S102 of FIG. 10). As a specific example, since a relocation start is basically permitted for the adjacent RNC 60 (relocation permitted cells are included), registered content of the first database is “START (PERMITTED)” (refer to FIG. 7). Registration is similar for adjacent RNCs 61 and 62 and others. “START (PERMITTED)”/“NOT START (INHIBITED)” of relocation processing can be designated for each adjacent radio network controller. In this case, a relocation start is inhibited for the RNC 61. It is because a communication line with a very large band capacity is prepared with the RNC 61, and there is a wish to prevent an occurrence of complex relocation processing than to make the communication line use efficient as described above.

Next, the second database generation unit 5034 registers a cell of a moving destination of the mobile station 40 to be inhibited for a relocation start in the second database 502 (Step S103 of FIG. 10). As shown in FIG. 8, for the RNC 60, the cells #321, #323, #325, and #327 near the covered area boundary are registered as inhibited target cells.

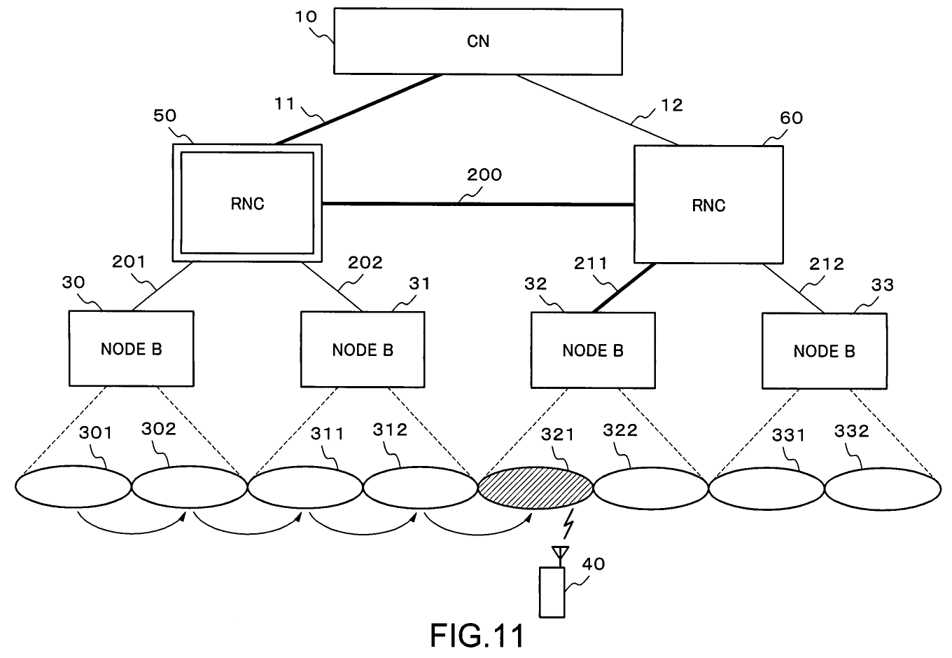

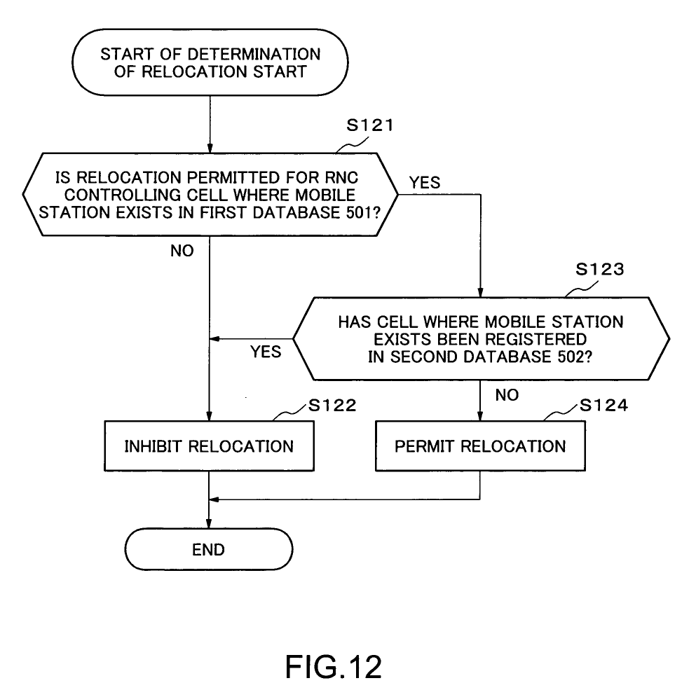

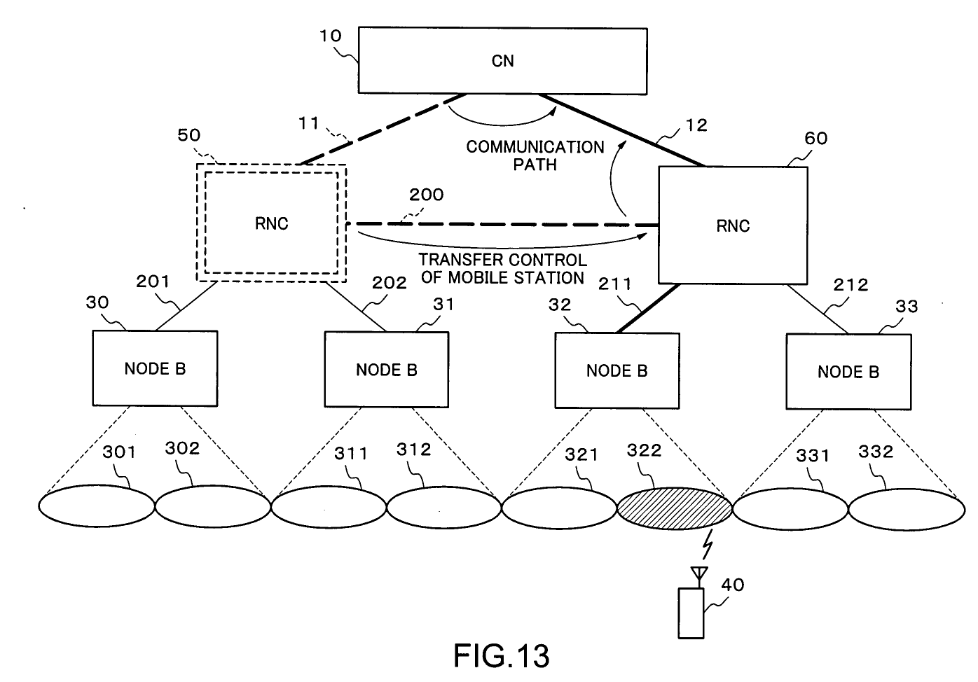

Next, a start determination operation of relocation processing according to the first exemplary embodiment of the present invention will be described. FIG. 11 is a conceptual diagram showing a handover situation of the mobile station 40. FIG. 12 is a flowchart showing a relocation start determination operation. FIG. 13 is a conceptual diagram showing an execution situation of relocation processing.

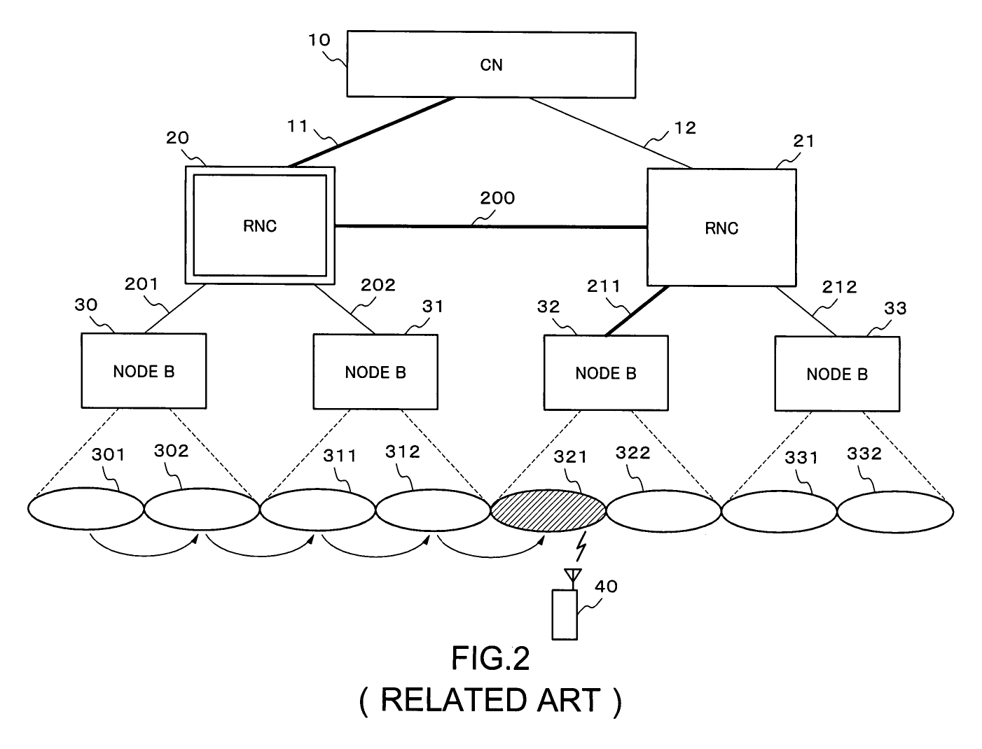

In FIG. 5, an operation from making a call by the mobile station 40 in the cell #301 to establishment of a communication path with the core network 10 is similar to that of FIG. 1 except that the RNCs 10 and 20 of FIG. 1 are respectively changed to the RNCs 50 and 60, and thus details of the operation will be omitted. Furthermore, when the mobile station 40 moves into an adjacent cell during communication, the RNC 50 executes handover processing. The handover operation till its entry into the cell #321 is similar to that of FIG. 2.

As shown in FIG. 11, according to the first exemplary embodiment of the present invention, when the mobile station 40 moves to enter the cell #321 (a cell of a moving destination of the mobile station 40) which is under control of the Node B 32, the Node B 32 is not under control of the RNC 50 but under control of the adjacent RNC 60 (a radio network controller of a moving destination of the mobile station 40). The RNC 60 recognizes and understands the movement of the mobile station 40 into the cell #321 based on information from the Node B 32. Then, the RNC 60 transmits the information to the RNC 50 through the communication line 200 between the RNCs 50 and 60. Hence, the call made by the mobile station 40 is maintained (handed over) from the RNC 50 through the communication line 200, the RNC 60, the communication line 211, and the Node B 32 as shown in FIG. 11.

The relocation start determination unit 503 of the RNC 50 executes a relocation start determination operation shown in FIG. 12. An outline of the operation is as follows. The relocation start determination unit 503 searches the first database 501 and the second database 502. From the first database 501, relocation start is basically permitted when the mobile station 40 moves to cells under control of the RNC 60. However, since the cell #321 has been registered in the second database 502, relocation processing is not started. When the mobile station 40 further moves into the cell #322, since the cell #322 has not been registered in the second database 502, relocation processing is started.

Referring to FIG. 6 and FIG. 12, the operation will be described in detail. The central controller (not shown) of the RNC 50 recognizes and understands that the mobile station 40 now exists in the cell #321 under the control of the adjacent RNC 60 based on information received from the RNC 60 through the communication line 200. Accordingly, information 5041 (the RNC 60) showing the RNC of a moving destination of the mobile station 40 and information 5044 (cell #321 under control of RNC 60) showing the cell of a moving destination of the mobile station 40 are obtained.

The first determination unit 5031 of the relocation start determination unit 503 searches the first database 501 based on the information 5041 to determine relocation start permission for the RNC indicated by the information 5041 (Step S121).

If the relocation start permission is not determined (that is, relocation is inhibited) (“NO” in Step S121), the first determination unit 5031 determines relocation start inhibition (Step S122) to output an inhibition determination result 5042 (FIG. 6).

If the relocation start permission is determined (“YES” in Step S121), relocation start permission 5043 is determined to proceed to determination of the second determination unit 5032. The second determination unit 5032 searches the second database 502 based on the information 5044 to determine whether the cell indicated by the information 5044 is registered or not (Step S123).

If the cell has been registered in the second database 502 (“YES” in Step S123), the second determination unit 5032 determines relocation start inhibition (Step S122) to output an inhibition determination result 5045 (FIG. 6). On the other hand, if the cell has not been registered in the second database 502 (“NO” in Step S123), the second determination unit 5032 determines relocation start permission (Step S124) to output a permission determination result 5046 (FIG. 6).

In a case of a situation shown in FIG. 11 (the mobile station 40 exists in the cell #321 under control of the adjacent RNC 60), “YES” is set in both Steps S121 and S123 based on registered contents of FIG. 7 and FIG. 8, and a relocation start is inhibited in Step S122. The central controller (not shown) of the RNC 50 maintains the communication path (FIG. 11) in normal handover processing without starting relocation processing based on the determination result 5045 (“RELOCATION INHIBITED”) of the relocation start determination unit 503.

When the mobile station 40 further moves to enter the cell #322, upon reception of its information from the adjacent RNC 60, the RNC 50 executes a relocation start determination operation shown in FIG. 12 again by the relocation start determination unit 503. In this case, information 5041 is “RNC 60”, and information 5044 is “cell #322 under control of RNC 60”. From registered contents of FIG. 7 and FIG. 8, “YES” is set in Step S121 while “NO” is set in Step S123, and a relocation start is permitted in Step S124. The central controller (not shown) of the RNC 50 executes relocation processing based on the determination result 5046 (“RELOCATION PERMITTED”) of the relocation start determination unit 503. In other words, the RNC 50 transfers a control of the mobile station 40 to the RNC 60, and switches a communication path between the core network 10 and the RNC 60 from the communication lines 11 and 200 to the communication line 12 (FIG. 13).

According to the present invention, for example, even after the mobile communication system is built up, necessary information can be input from the maintenance terminal or the like and registered in the first database 501 and the second database 502 by the first database generation unit 5033 and the second database generation unit 5034, respectively. Hence, timing of a relocation start can be flexible.

This exemplary embodiment produces the following effects.

First, since the information registered in the first database 501 is retrieved to decide the first determination of the relocation processing start for each adjacent radio network controller, unnecessary (unfavorable) relocation processing can be avoided.

Second, since the registration of the information of the cell where the mobile station 40 exists in the second database 502 is retrieved to make the final determination as to the relocation processing start, complex processing for detecting location coordinates of the mobile station 40 in real time is not necessary for at least the relocation start determination.

Third, a timing of the relocation processing start (i.e., distance from a boundary of covered area of the radio network controller) can be adjusted by controlling the number of cells registered in the second database 502.

### Second Exemplary Embodiment

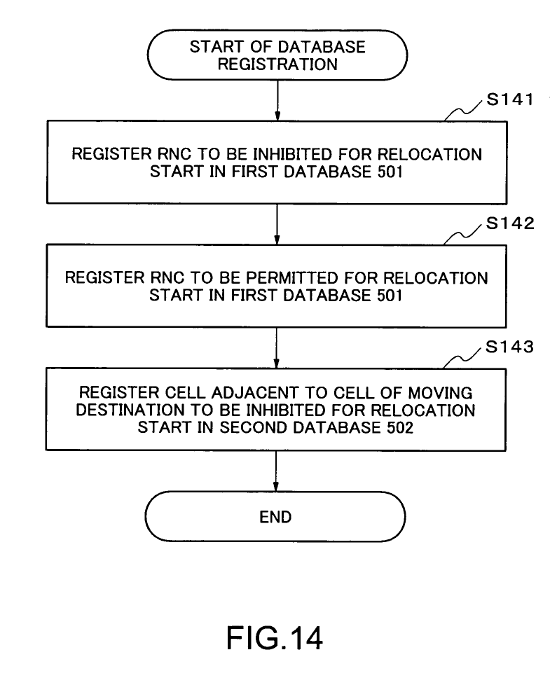

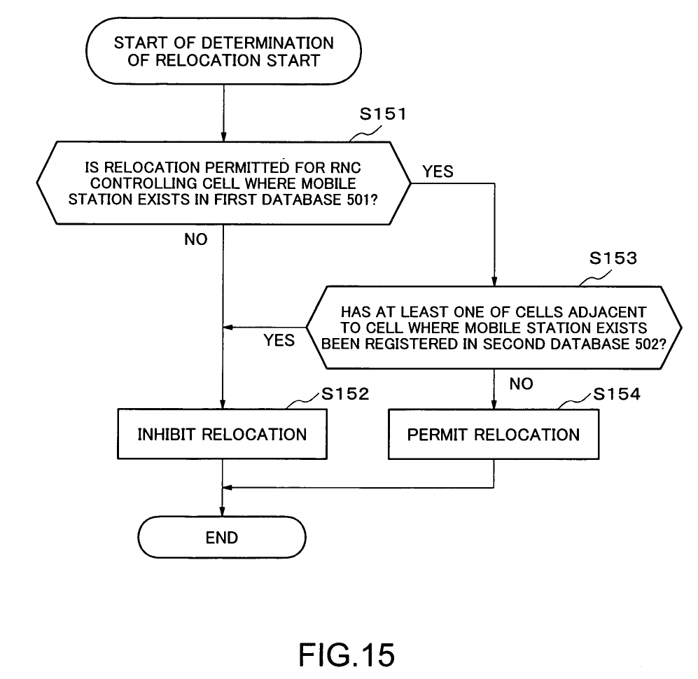

Next, a second exemplary embodiment of the present invention will be described. According to the second exemplary embodiment, as compared with the first exemplary embodiment, registered contents of the second database 502 and determination operation of the second determination unit 5032 are changed. Other components, structure and operations are similar to those of the first exemplary embodiment. Referring to flowcharts of FIG. 14 and FIG. 15, an operation of the second exemplary embodiment will be described.

In a database registration procedure of the second exemplary embodiment shown in FIG. 14, a registration procedure and contents in the first database 501 are similar to those of the first exemplary embodiment (FIG. 10). In other words, Steps S141 and S142 of FIG. 14 are identical to Steps S101 and S102 of FIG. 10, respectively. In Step S143 of FIG. 14, different from FIG. 10, the second database generation unit 5034 registers information of cells adjacent to the cell of a moving destination of the mobile station 40 inhibited for a relocation start in the second database 502.

In a relocation start determination procedure of the second exemplary embodiment shown in FIG. 15, determination process referring to the first database 501 are similar to those of the first exemplary embodiment (FIG. 12). In other words, Steps S151 and S152 of FIG. 15 are identical to Steps S121 and S122 of FIG. 12, respectively. In Step S153 of FIG. 15, different from FIG. 12, a second determination unit 5032 searches the second database 502 to determine whether even one of cells adjacent to the cell of a moving destination of the mobile station 40 where the mobile station 40 exists is registered or not. If registered, “YES” is set to inhibit a relocation processing start (Step S152). If not registered, in other words, if none of the adjacent cells of the cell of a moving destination of the mobile station 40 has been registered, “NO” is set to permit a relocation start (Step S154).

An operation and effects of the second exemplary embodiment will be described by way of specific examples. A specific operation example will be described by presuming that registered results of the first database 501 and the second database 502 are respectively as shown in FIG. 7 and FIG. 8 and cell arrangement is as shown in FIG. 9.

In FIG. 9, when the mobile station 40 moves into the cell #321 under control of the RNC 60, “YES” is set in Step S151 of FIG. 15 to proceed to Step S153. In Step S153, at least the cell #323 among adjacent cells of the cell #321 is registered in the second database 502. Accordingly, determination of the second determination unit 5032 becomes “YES” in Step S153 to inhibit a relocation start (Step S152). Hence, relocation processing is not started. When the mobile station 40 moves into the cells #323, #325, and #327, similarly, relocation processing is not started.

Next, when the mobile station 40 moves into the cell #322, in Step S153 of FIG. 15, at least the cell #323 among adjacent cells of the cell #322 is registered in the second database 502. Accordingly, determination of the second determination unit 5032 becomes “YES” in Step S153 to inhibit a relocation start (Step S152). Hence, relocation processing is still not started. When the mobile station 40 moves into the cells #324 and #326, similarly, relocation processing is not started.

Next, when the mobile station 40 moves into the cell #333, in Step S153 of FIG. 15, none of adjacent cells #331, #322, #324, and #335 of the cell #333 of a moving destination of the mobile station 40 are registered in the second database 502. Accordingly, determination of the second determination unit 5032 becomes “NO” in Step S153 to permit a relocation start (Step S154). As a result, relocation processing is executed. When the mobile station 40 moves into the cells #331, #335, and #337, similarly, relocation processing is started.

Comparison in timing of relocation starts based on the movement of the mobile station 40 shows that the relocation start for the second exemplary embodiment is later than that for the first exemplary embodiment even while contents of the first and second databases are identical. In other words, relocation is started in the second exemplary embodiment when the mobile station 40 is farther apart from the boundary of the RNC 50. In the first exemplary embodiment, information of the inhibition target cells must be directly registered to inhibit a relocation start in the cells #322, #324, and #326. According to the second exemplary embodiment, however, this is not necessary. In other words, in the second exemplary embodiment, as compared with the first exemplary embodiment, it is possible to reduce a registered information amount (the number of registered cells) of the second database 502.

### Third Exemplary Embodiment

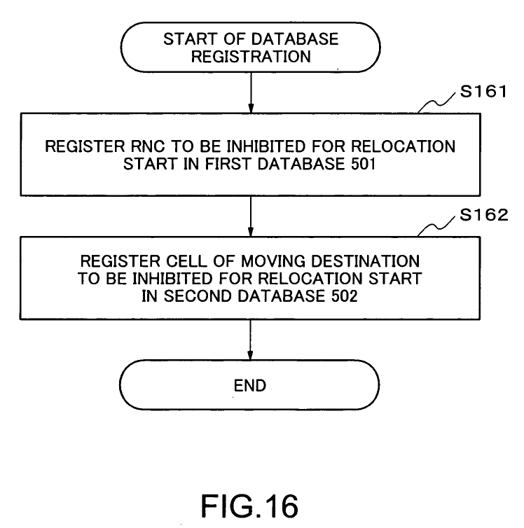

Next, a third exemplary embodiment of the present invention will be described. According to the third exemplary embodiment, as compared with the first exemplary embodiment, registered contents of the first database 501 and determination operation of the first determination unit 5031 are changed. Other components, structure and operations are similar to those of the first exemplary embodiment. Referring to FIG. 16 to FIG. 18, an operation of the third exemplary embodiment will be described.

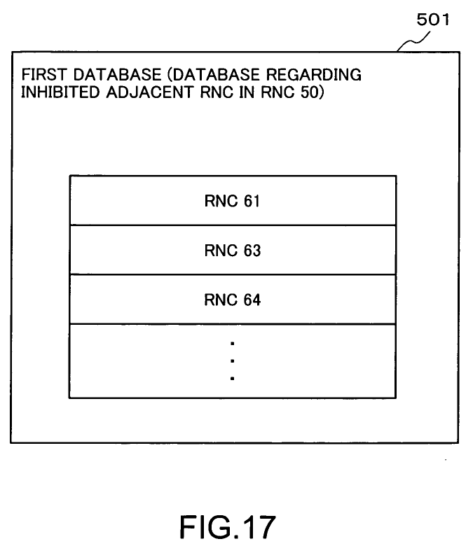

In a database registration procedure of the third exemplary embodiment shown in FIG. 16, a registration procedure and contents in the second database 502 are similar to those of the first exemplary embodiment (FIG. 10). In other words, Step S162 of FIG. 16 is identical to Step S103 of FIG. 10. In Step S161 of FIG. 16, different from FIG. 10, the first data base generation unit 5033 registers only information of the adjacent RNC inhibited for a relocation start in the first database 501. For example, a registration content of the first database 501 is as shown in FIG. 17.

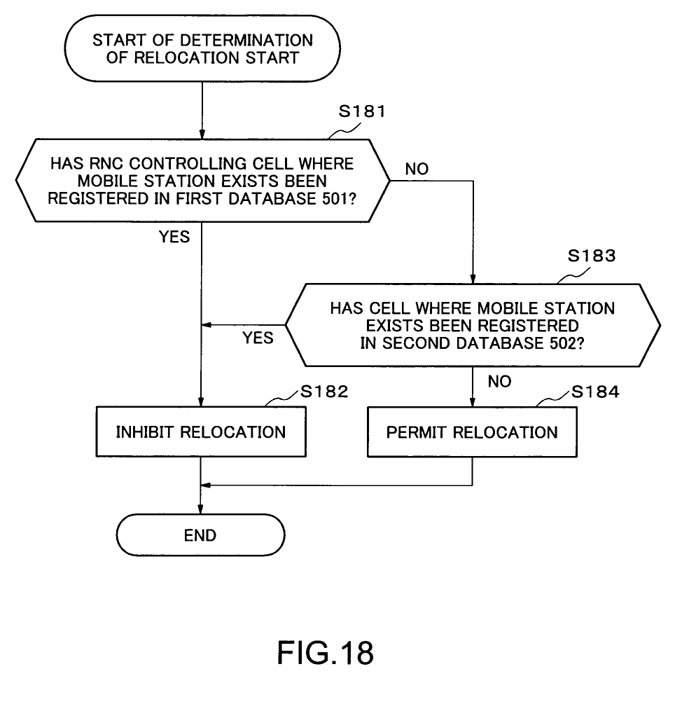

Next, in a relocation start determination procedure of the third exemplary embodiment shown in FIG. 18, determination process referring to the second database 502 is similar to those of the first exemplary embodiment (FIG. 12). In other words, Steps S183 and S184 of FIG. 18 are identical to Steps S123 and S124 of FIG. 12. In Step S181 of FIG. 18, different from FIG. 12, the first determination unit 5031 searches the first database 501 to determine whether the RNC which controls a cell where the mobile station 40 exists is registered or not. If registered, “YES” is set to inhibit a relocation processing start (Step S182). If not registered, “NO” is set to permit a relocation processing start for the RNC of a moving destination of the mobile station 40. Next, inhibited cell determination (Step S183) is executed in the second determination unit 5032.

According to the third exemplary embodiment, the radio network controller of a moving destination of the mobile station 40 inhibited for a relocation processing start alone is registered in the first database 501, while information of a radio network controller permitted for a relocation start is not registered. In other words, according to the third exemplary embodiment, as compared with the first exemplary embodiment, it is possible to reduce a registered information amount (the number of registered radio network controllers) of the first database 501.

### Fourth Exemplary Embodiment

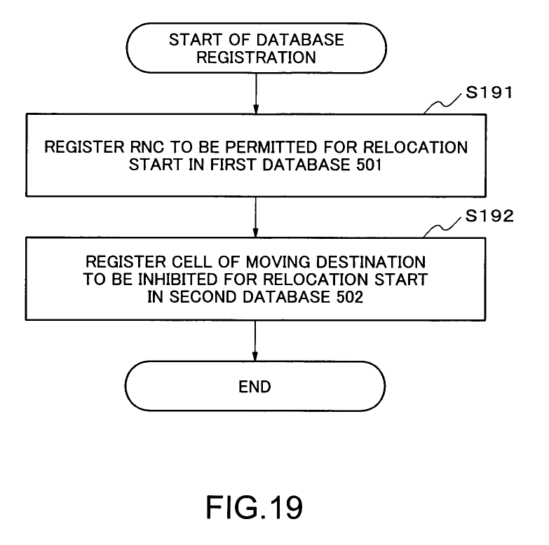

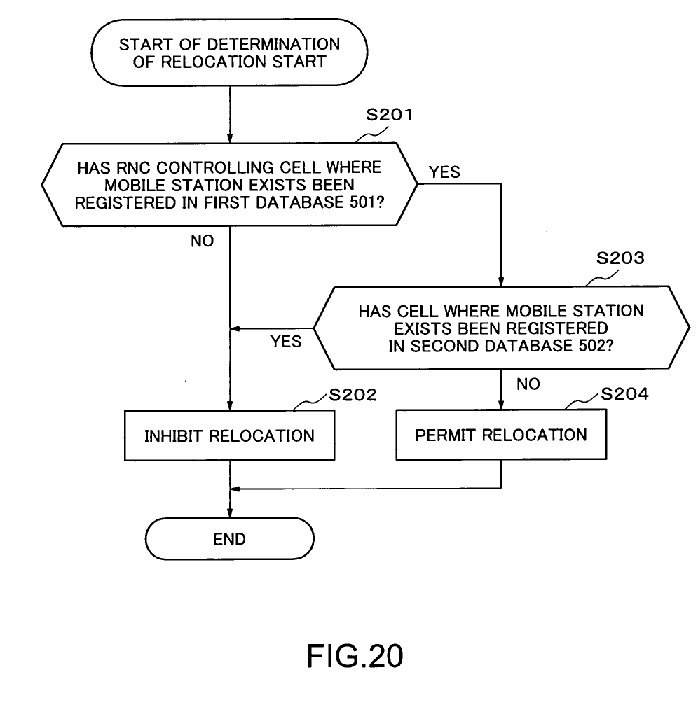

Next, a fourth exemplary embodiment of the present invention will be described. In contrast to the third exemplary embodiment, a radio network controller of a moving destination of the mobile station 40 permitted for a relocation start alone is registered in the first database 501. According to the fourth exemplary embodiment, as compared with the first exemplary embodiment, registered contents of the first database 501 and determination operation of the first determination unit 5031 are changed. Other components, structure and operations are similar to those of the first exemplary embodiment. Referring to flowcharts of FIG. 19 and FIG. 20, an operation of the fourth exemplary embodiment will be described.

In a database registration procedure of the fourth exemplary embodiment shown in FIG. 19, a registration procedure and contents in the second database 502 are similar to those of the first exemplary embodiment (FIG. 10). In other words, Step S192 of FIG. 19 is identical to Step S103 of FIG. 10. In Step S191 of FIG. 19, different from FIG. 10, the first database generation unit 5033 registers only information of an adjacent RNC permitted for a relocation start in the first database 501.

Next, in a relocation start determination procedure of the fourth exemplary embodiment shown in FIG. 20, determination process referring to the second database 502 are similar to those of the first exemplary embodiment (FIG. 12). In other words, Steps S203 and S204 of FIG. 20 are identical to Steps S123 and S124 of FIG. 12. In Step S201 of FIG. 20, different from FIG. 12, the first determination unit 5031 searches the first database 501 to determine whether information of the RNC which controls a cell where the mobile station 40 exists is registered or not. If not registered, “NO” is set to inhibit a relocation processing start (Step S202). If registered, “YES” is set to permit a relocation processing start for the RNC of a moving destination of the mobile station 40. Next, inhibited cell determination (Step S203) is executed in the second determination unit 5032.

According to the fourth exemplary embodiment, information of the radio network controller of a moving destination of the mobile station 40 permitted for a relocation processing start alone is registered in the first database 501, while information of a radio network controller inhibited for a relocation start is not registered. In other words, according to the fourth exemplary embodiment, as compared with the first exemplary embodiment, it is possible to reduce a registered information amount (the number of registered radio network controllers) of the first database 501.

As described above, each of the exemplary embodiments of the present invention can be realized by reading and executing the program for executing the relocation processing start determination function from the storage medium by the computer or the processor. However, each determination unit can be realized by hardware.

While this invention has been described in connection with certain preferred embodiments, it is to be understood that the subject matter encompassed by way of the present invention is not to be limited to those specific embodiments. On the contrary, it is intended for the subject matter of the invention to include all alternative, modification, and equivalents as can be included within the spirit and scope of the following claims.

Further, it is the inventor's intention to retain all equivalents of the claimed invention even if the claims are amended during prosecution.

What is claimed is:

1. A method of determining a relocation start in a mobile communication system in which each of service areas is constituted of a plurality of cells, comprising:
determining, when a mobile station moves into a different service area, whether the service area is a relocation inhibition target or not based on prestored first data;
determining, when the service area is not a relocation inhibition target, whether a cell where the mobile station exists is a relocation inhibition target or not based on prestored second data; and
determining advisability of a start of relocation processing based on the determination results.

2. A method of determining a relocation start in a mobile communication system in which each of service areas covered by each of radio network controllers is constituted of a plurality of cells, comprising:
determining, when a mobile station moves into a service area of an adjacent radio network controller, whether the adjacent radio network controller is a relocation inhibition target or not based on a first database;
determining, when the adjacent radio network controller is not a relocation inhibition target, whether a cell where the mobile station exists is a relocation inhibition target or not based on a second database; and
determining advisability of a start of relocation processing based on the determination results.

3. A method of determining a relocation start in a mobile communication system in which each of service areas covered by each of radio network controllers is constituted of a plurality of cells, wherein the radio network controller for controlling a mobile station comprises:
a first database for storing information to determine an adjacent radio network controller of a relocation inhibition target; and
a second database for storing information to determine a cell of a relocation inhibition target in a service area covered by an adjacent radio network controller, and
wherein the method executed in the radio network controller includes determining advisability of a start of relocation processing by referring to the first and second databases when the mobile station moves into a service area covered by an adjacent radio network controller.

4. A method of determining a relocation start in a mobile communication system in which each of service areas covered by each of radio network controllers is constituted of a plurality of cells, executing in the radio network controller:
a first database registration step of registering information regarding an adjacent radio network controller of a relocation inhibition target in a first database;
a second database registration step of registering information regarding a cell of a relocation inhibition target in a service area covered by an adjacent radio network controller in a second database; and
a determination step of determining advisability of a start of relocation processing by referring to the first and second databases when a mobile station moves into a service area covered by an adjacent radio network controller.

5. The method of determining a relocation start in the mobile communication system according to claim 4, wherein the determination step comprises:
a first determination sub-step of determining whether the adjacent radio network controller covering the cell where the mobile station exists is a relocation inhibition target or not by referring to the first database; and
a second determination sub-step of determining, when a determination result of the first determination sub-step shows that the adjacent radio network controller is not a relocation inhibition target, whether the cell where the mobile station exists is a relocation inhibition target or not by referring to the second database.

6. The method of determining a relocation start in the mobile communication system according to claim 5, wherein when the first determination sub-step determines that the adjacent radio network controller covering the cell where the mobile station exists is a relocation inhibition target, start inhibition of relocation processing is determined.

7. The method of determining a relocation start in the mobile communication system according to claim 5, wherein in the second determination sub-step, start inhibition of relocation processing is determined when the cell where the mobile station exists is determined to be a relocation inhibition target, and start permission of relocation processing is determined when the cell where the mobile station exists is determined not to be a relocation inhibition target.

8. The method of determining a relocation start in the mobile communication system according to claim 5, wherein information of an adjacent radio network controller inhibited for a start of relocation processing is registered in the first database in the first database registration step, and the adjacent radio network controller registered in the first database is determined to be a relocation inhibition target in the first determination sub-step.

9. The method of determining a relocation start in the mobile communication system according to claim 5, wherein information of an adjacent radio network controller permitted for a start of relocation processing is registered in the first database in the first database registration step, and the adjacent radio network controller registered in the first database is determined not to be a relocation inhibition target in the first determination sub-step.

10. The method of determining a relocation start in the mobile communication system according to claim 5, wherein information of a cell inhibited for a start of relocation processing is registered in the second database in the second database registration step, and the cell registered in the second database is determined to be a relocation inhibition target in the second determination sub-step.

11. The method of determining a relocation start in the mobile communication system according to claim 5, wherein information of a cell adjacent to a cell inhibited for a start of relocation processing is registered in the second database in the second database registration step, and, when the cell where the mobile station exists is adjacent to the cell registered in the second database in the second determination sub-step, the cell where the mobile station exists is determined to be a relocation inhibition target.

12. A radio network controller for controlling a mobile station in a mobile communication system in which each of service areas covered by each of radio network controllers is constituted of a plurality of cells, comprising:
first storage for storing information to determine an adjacent radio network controller of a relocation inhibition target;
second storage for storing information to determine a cell of a relocation inhibition target in a service area covered by an adjacent radio network controller; and
a relocation start determination unit for determining advisability of a start of relocation processing by referring to the first and second storage when a mobile station moves into a service area covered by an adjacent radio network controller.

13. The radio network controller according to claim 12, wherein the relocation start determination unit comprises:
a first determination unit for determining whether the adjacent radio network controller covering the cell where the mobile station exists is a relocation inhibition target or not by referring to the first storage; and
a second determination unit for determining, when a determination result of the first determination unit shows that the adjacent radio network controller is not a relocation inhibition target, whether the cell where the mobile station exists is a relocation inhibition target or not by referring to the second storage.

14. The radio network controller according to claim 13, wherein when the first determination unit determines that the adjacent radio network controller covering the cell where the mobile station exists is a relocation inhibition target, start inhibition of relocation processing is determined.

15. The radio network controller according to claim 13, wherein in the second determination unit, start inhibition of relocation processing is determined when the cell where the mobile station exists is determined to be a relocation inhibition target, and start permission of relocation processing is determined when the cell where the mobile station exists is determined not to be a relocation inhibition target.

16. The radio network controller according to claim 13, further comprising a first data generation unit for registering information of an adjacent radio network controller inhibited for a start of relocation processing in the first storage.

17. The radio network controller according to claim 16, wherein the first determination unit determines that the adjacent radio network controller registered in the first storage is a relocation inhibition target.

18. The radio network controller according to claim 13, further comprising a first data generation unit for registering information of an adjacent radio network controller permitted for a start of relocation processing in the first storage.

19. The radio network controller according to claim 18, wherein the first determination unit determines that the adjacent radio network controller registered in the first storage is not a relocation inhibition target.

20. The radio network controller according to claim 13, further comprising a second data generation unit for registering information of a cell inhibited for a start of relocation processing in the second storage.

21. The radio network controller according to claim 20, wherein the second determination unit determines that the cell registered in the second storage is a relocation inhibition target.

22. The radio network controller according to claim 13, further comprising a second data generationunit for registering information of a cell adjacent to a cell inhibited for a start of relocation processing in the second storage.

23. The radio network controller according to claim 22, wherein the second determination unit determines that the cell where the mobile station exists is a relocation inhibition target when the cell where the mobile station exists is adjacent to the cell registered in the second storage device.

24. A radio network controller for controlling a mobile station in a mobile communication system in which each of service areas covered by each of radio network controllers is constituted of a plurality of cells, comprising:
a first storage means for storing information to determine an adjacent radio network controller of a relocation inhibition target;
a second storage means for storing information to determine a cell of a relocation inhibition target in a service area covered by an adjacent radio network controller; and
a relocation start determination means for determining advisability of a start of relocation processing by referring to the first and second storage means when a mobile station moves into a service area covered by an adjacent radio network controller.

25. A mobile communication system in which each of service areas covered by each of radio network controllers is constituted of a plurality of cells, wherein the radio network controller comprises:
a first database for storing information to determine an adjacent radio network controller of a relocation inhibition target;
a second database for storing information to determine a cell of a relocation inhibition target in a service area covered by an adjacent radio network controller; and
a relocation start determination unit for determining advisability of a start of relocation processing by referring to the first and second databases when a mobile station moves into a service area covered by an adjacent radio network controller.

26. A mobile communication system in which each of service areas covered by each of radio network controllers is constituted of a plurality of cells, wherein the radio network controller comprises:
a first database means for storing information to determine an adjacent radio network controller of a relocation inhibition target;
a second database means for storing information to determine a cell of a relocation inhibition target in a service area covered by an adjacent radio network controller; and
a relocation start determination means for determining advisability of a start of relocation processing by referring to the first and second database means when a mobile station moves into a service area covered by an adjacent radio network controller.

27. A mobile communication system in which each of service areas covered by each of radio network controllers is constituted of a plurality of cells, the system executing:
determining, when a mobile station moves into a service area of an adjacent radio network controller, whether the adjacent radio network controller is a relocation inhibition target or not based on a first database;
determining, when the adjacent radio network controller is not a relocation inhibition target, whether a cell where the mobile station exists is a relocation inhibition target or not based on a second database; and
determining advisability of a start of relocation processing based on the determination results.

28. A mobile communication system in which each of service areas is constituted of a plurality of cells, the system executing:
determining, when a mobile station moves into a different service area, whether the service area is a relocation inhibition target or not based on prestored first data;
determining, when the service area is not a relocation inhibition target, whether a cell where the mobile station exists is a relocation inhibition target or not based on prestored second data; and
determining advisability of a start of relocation processing based on the determination results.
